(19) United States
(12) Patent Application Publication
(10) Pub. No.: US 2015/0264414 A1
(43) Pub. Date: Sep. 17, 2015

(54) INFORMATION PROCESSING DEVICE AND METHOD, INFORMATION PROCESSING TERMINAL AND METHOD, AND PROGRAM

(71) Applicant: SONY CORPORATION, TOKYO (JP)

(72) Inventor: MASAYUKI MIYAMOTO, KANAGAWA (JP)

(21) Appl. No.: 14/639,576

(22) Filed: Mar. 5, 2015

(30) Foreign Application Priority Data
Mar. 14, 2014 (JP) 2014-051896

(51) Int. Cl. H04N 21/2343; H04N 21/239; H04N 21/6587; H04N 21/438; H04N 21/6375; H04N 21/231; H04N 21/274

(52) U.S. Cl. CPC H04N 21/23439; H04N 21/231; H04N 21/2393; H04N 21/274; H04N 21/438; H04N 21/6375; H04N 21/6587

(57) ABSTRACT

An information processing device includes a viewed proportion calculation unit which calculates a viewed proportion of content in a first video distribution format based on a reproduction end point of the content in the first video distribution format that is acquired from an information processing terminal that reproduces the content in the first video distribution format and run time information of the content in the first video distribution format, a viewed proportion memory which holds the viewed proportion of the content in the first video distribution format that is calculated by the viewed proportion calculation unit, and a viewed proportion reading unit which reads the viewed proportion of the content in the first video distribution format that is held in the viewed proportion memory in response to a reproduction start request of the content in a second video distribution format that differs from the first video distribution format.

### CROSS REFERENCE TO RELATED APPLICATIONS

This application claims the benefit of Japanese Priority Patent Application JP 2014-051896 filed Mar. 14, 2014, the entire contents of which are incorporated herein by reference.

### BACKGROUND

The present disclosure relates to an information processing device and method, an information processing terminal and method, and a program. In particular, the present disclosure relates to an information processing device and method, an information processing terminal and method, and a program, each of which is capable of smoothly performing viewing succession.

For example, there is a viewing method in which content that is viewed to part way through on a device A at home on one day, is viewed on a different device B from the continuation at a workplace on the next day, and hereinafter, the viewing method will be referred to as viewing succession. Such viewing succession being possible is markedly convenient for a user.

Japanese Patent No. 2009-44416 is an example of the related art.

### SUMMARY

However, in actuality, when the video distribution format of the content viewed on device A is different from that of the content viewed on device B, there is a case in which the actual lengths of the overall content differ, and viewing succession may not be smoothly performed.

It is desirable to smoothly perform the viewing succession.

According to an embodiment of the present disclosure, there is provided an information processing device which includes a viewed proportion calculation unit which calculates a viewed proportion of content in a first video distribution format based on a reproduction end point of the content in the first video distribution format that is acquired from an information processing terminal that reproduces the content in the first video distribution format and run time information of the content in the first video distribution format, a viewed proportion memory which holds the viewed proportion of the content in the first video distribution format that is calculated by the viewed proportion calculation unit, and a viewed proportion reading unit which reads the viewed proportion of the content in the first video distribution format that is held in the viewed proportion memory in response to a reproduction start request of the content in a second video distribution format that differs from the first video distribution format.

According to another embodiment of the present disclosure, there is provided an information processing method performed by an information processing device. The method includes calculating a viewed proportion of content in a first video distribution format based on a reproduction end point of the content in the first video distribution format that is acquired from an information processing terminal that reproduces the content in the first video distribution format and run time information of the content in the first video distribution format, holding the viewed proportion of the content in the first video distribution format in viewed proportion memory, and reading the viewed proportion of the content in the first video distribution format that is held in the viewed proportion memory in response to a reproduction start request of the content in a second video distribution format that differs from the first video distribution format.

According to still another embodiment of the present disclosure, there is provided an information processing terminal which includes a viewed proportion calculation unit which calculates a viewed proportion of content in a first video distribution format based on a reproduction end point of the content in the first video distribution format and run time information of the content in the first video distribution format, and a viewed proportion transmission unit which transmits the viewed proportion of the content in the first video distribution format that is calculated by the viewed proportion calculation unit to an information processing device.

According to still another embodiment of the present disclosure, there is provided an information processing method performed by an information processing terminal. The method includes calculating a viewed proportion of content in a first video distribution format based on a reproduction end point of the content in the first video distribution format and run time information of the content in the first video distribution format, and transmitting the viewed proportion of the content in the first video distribution format that is calculated to an information processing device.

According to still another embodiment of the present disclosure, there is provided a program for causing a computer to function as a viewed proportion calculation unit which calculates a viewed proportion of content in a first video distribution format based on a reproduction end point of the content in the first video distribution format and run time information of the content in the first video distribution format, and a viewed proportion transmission unit which transmits the viewed proportion of the content in the first video distribution format that is calculated by the viewed proportion calculation unit to an information processing device.

According to still another embodiment of the present disclosure, there is provided an information processing method performed by an information processing device. The method includes calculating a viewed proportion of content in a first video distribution format based on a reproduction end point of the content in the first video distribution format that is acquired from an information processing terminal that generates the content in the first video distribution format and run time information of the content in the first video distribution format, holding the viewed proportion of the content in the first video distribution format in viewed proportion memory, and reading the viewed proportion of the content in the first video distribution format that is held in the viewed proportion memory in response to a reproduction start request of the content in a second video distribution format that differs from the first video distribution format.

According to still another embodiment of the present disclosure, a viewed proportion of content in a first video distribution format is calculated based on a reproduction end point of the content in the first video distribution format and run time information of the content in the first video distribution format, and the viewed proportion of the content in the first video distribution format that is calculated is transmitted to an information processing device.

According to an embodiment of the present disclosure, it is possible to perform reproduction succession. In particular, it is possible to smoothly perform the reproduction succession.

Note that, the effects described in the present specification are merely exemplary, the effects of the present technology are not limited to the effects described in the present specification, and there may be additional effects.

### BRIEF DESCRIPTION OF THE DRAWINGS

FIG. 1 is a diagram illustrating a difference in run times caused by video distribution formats;

FIG. 2 is a diagram illustrating the concept of an embodiment of the present technology;

FIG. 3 is a block diagram illustrating a first configuration example of a video distribution system of an embodiment of the present technology;

FIG. 4 is a block diagram illustrating a configuration example of a server;

FIG. 5 is a block diagram illustrating a configuration example of a device;

FIG. 6 is a block diagram illustrating a functional configuration example of a server;

FIG. 7 is a flowchart illustrating the processes of the video distribution system of FIG. 3;

FIG. 8 is a block diagram illustrating a second configuration example of a video distribution system of an embodiment of the present technology;

FIG. 9 is a block diagram illustrating a functional configuration example of a server;

FIG. 10 is a block diagram illustrating a functional configuration example of a device;

FIG. 11 is a flowchart illustrating the processes of the video distribution system of FIG. 8;

FIG. 12 is a block diagram illustrating a third configuration example of a video distribution system of an embodiment of the present technology;

FIG. 13 is a block diagram illustrating a functional configuration example of a device;

FIG. 14 is a block diagram illustrating a functional configuration example of a server;

FIG. 15 is a flowchart illustrating the processes of the video distribution system of FIG. 12;

FIG. 16 is a block diagram illustrating a fourth configuration example of a video distribution system of an embodiment of the present technology;

FIG. 17 is a block diagram illustrating a functional configuration example of a server; and

FIG. 18 is a flowchart illustrating the processes of the video distribution system of FIG. 16.

### DETAILED DESCRIPTION OF EMBODIMENTS

Hereafter, description will be given of embodiments for realizing the present disclosure (hereinafter, “embodiments”). Note that, the description will be given in the following order.
0. Outline
1. First Embodiment
2. Second Embodiment
3. Third Embodiment
4. Fourth Embodiment

### Outline

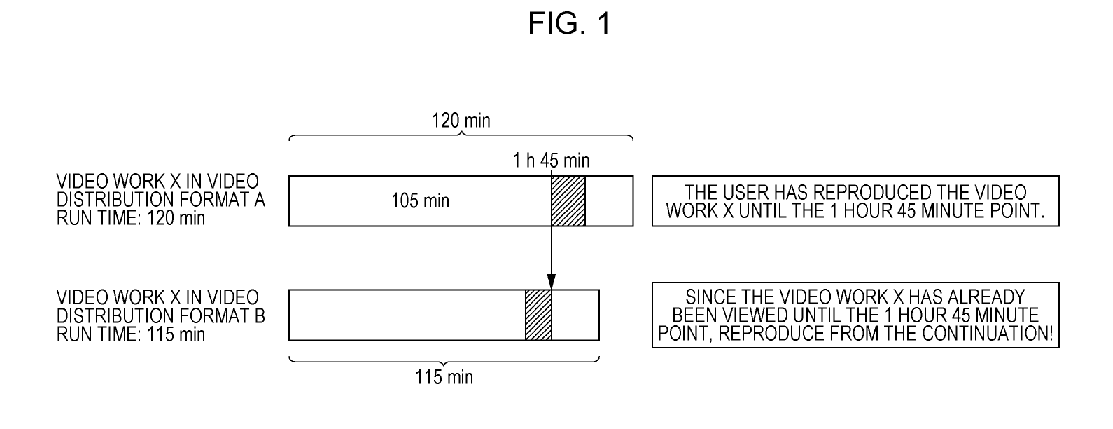

As illustrated in FIG. 1, a case will be considered in which the run time (showing time: length) of a video work (content) X in a video distribution format A is 120 minutes, and the run time of the video work X in a video distribution format B is 115 minutes. For example, it is assumed that a user views the video work X at home until the 1 hour 45 minute point in the video distribution format A on one day, and on the next day, views the video work X outside of the home from the 1 hour 45 minute point in the video distribution format B.

In this case, since the run time of the video work (content) X in the video distribution format B is five minutes shorter, when the video work X is viewed in the video distribution format B from the 1 hour 45 minute point in the video work X in the video distribution format A, the portion shaded with diagonal lines that is yet to be viewed is skipped, and it is difficult for the user to view the portion shaded with diagonal lines that is yet to be viewed.

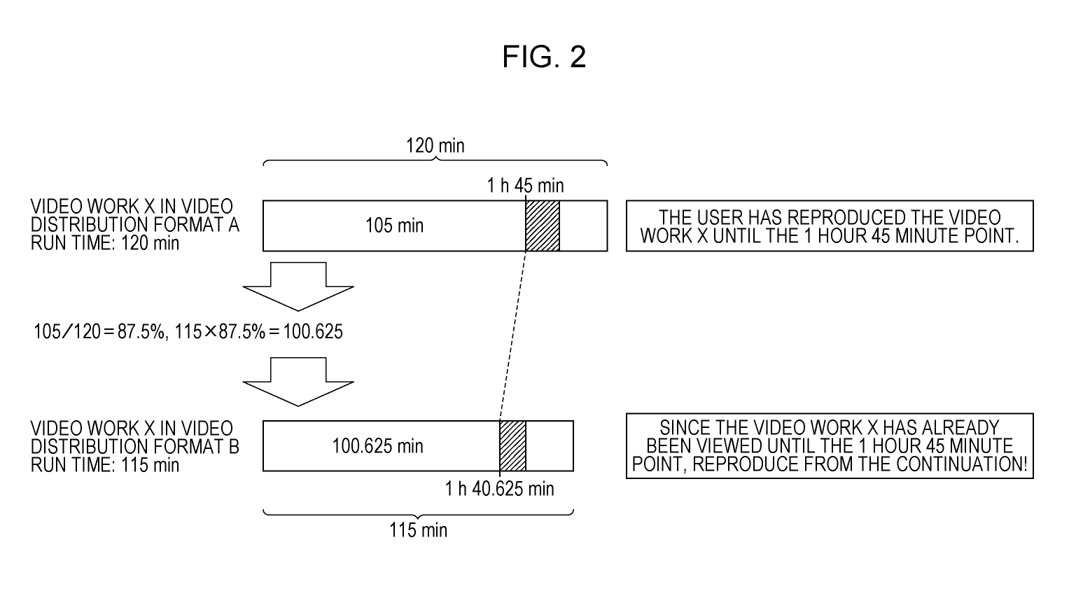

Therefore, in an embodiment of the present technology, a proportion is used instead of time in order to specify the reproduction position. In other words, as illustrated in FIG. 2, the proportion, 87.5%, is calculated from the 120 minute run time of the video work X in the video distribution format A and from the 115 minute run time of the video work X in the video distribution format B, and the result of multiplying the viewing time (115 minutes) by the proportion, 100.625 minutes, is specified as the reproduction position.

By specifying the reproduction position in this manner, it is possible to smoothly perform the viewing succession without the hatched portion that is yet to be viewed being skipped. Therefore, according to an embodiment of the present technology, it is possible to provide the viewing succession that will satisfy the user.

Hereinafter, description will be given in detail.

### First Embodiment

### Configuration Example of Video Distribution System

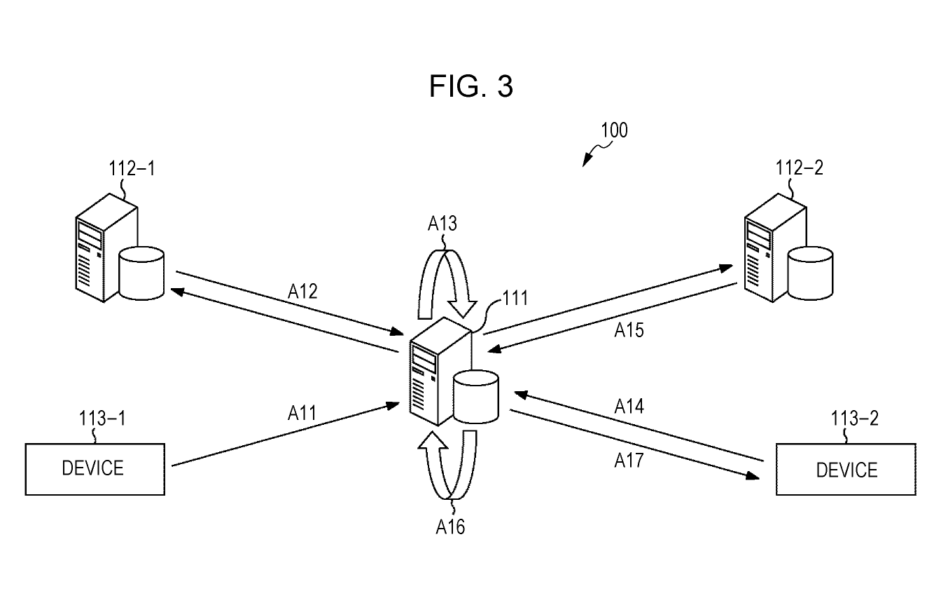

FIG. 3 is a diagram illustrating a first embodiment of a video distribution system to which an embodiment of the present technology is applied. The example of FIG. 3, illustrates an example in which viewing time transactions are performed using the time from the beginning via a server.

A video distribution system 100 illustrated in FIG. 3 is configured to include a server 111, content information servers 112-1 and 112-2, and devices 113-1 and 113-2.

Note that, the content information servers 112-1 and 112-2 are collectively referred to as the content information server 112 when it is not particularly necessary to distinguish therebetween, and the devices 113-1 and 113-2 are collectively referred to as the device 113 when it is not particularly necessary to distinguish therebetween.

The server 111, the content information servers 112-1 and 112-2, and the devices 113-1 and 113-2 are interconnected via a network such as the Internet.

The server 111 provides the user of the devices 113-1 and 113-2 with a content viewing succession service. The content viewing succession service is a service that allows the viewing of the continuation of the same content on a plurality of devices in different video distribution formats. Note that, the content that serves as the target may be stored on the server 111. The content that serves as the target may be DVD content, and may be acquired from a server that provides other content.

Here, the video distribution format (the video distribution service) refers to, for example, formats in which the run time of the content differs, such as the format type of streaming content (for example, downloadable assets and dash assets), region type of the DVD standard according to region (for example, the DVD standard in the US and the DVD standard in the UK), and the format type of the broadcast signal such as the PAL standard and the NTSC standard.

More specifically, in certain video distribution, there are maker-specific video distribution formats such as MPEG-DASH, HLS, DVD, Blu-ray Disc (registered trademark), and the video distribution formats contain system formats (file containers) such as MPEG2-PG, TS, MP4, or MXF. Furthermore, the system formats contain video formats such as MPEG2, H.264, and H.265, audio formats such as MPEG2-AAC, DTS, and Dolby digital, and subtitle formats such as PNG, and SMPTE-TT. The multi-layer formats can also be considered to be a single video distribution format.

For example, it is possible for the video distribution format A and the video distribution format B to be of the same application format, but to be separate files. This is because, when considering a Blu-ray Disc (registered trademark) as one layer of the same application format, even if the application format is the same, there is a case in which the frame rate constraints differ when the resolutions differ. In this manner, even if the application formats is the same in the same video content X, if the resolutions are different, it is possible that the run times will differ.

As described above, with regard to the same content, all formats in which the run times differ can be considered to be video distribution formats.

The content information server 112-1 has an information table of the run times (showing times) of various contents in the video distribution format A, and provides the corresponding information to the server 111 that accesses the content information server 112-1.

The content information server 112-2 has an information table of the run times (showing times) of various contents in the video distribution format B, and provides the corresponding information to the server 111 that accesses the content information server 112-2.

The devices 113-1 and 113-2 are each configured to be one of a recording reproduction device, a personal computer, a portable terminal, a multi-functional portable telephone, or the like, any one of which a user may have. The devices 113-1 and 113-2 access the server 111 according to a user operation, and reproduce the content in the video distribution format corresponding to the device.

In this case, according to the video distribution system 100, it becomes possible to view the content X at one time in the video distribution format A until a certain point on the device 113-1, and to view the content X at another time in the video distribution format B from the certain point on the device 113-2.

Specific description will be given of the video distribution system 100. In the device 113-1, as illustrated by an arrow A11, when the content X is viewed by the user until a certain point in the video distribution format A, the server 111 acquires information of the reproduction end point from the device 113-1. As illustrated by an arrow A12, the server 111 accesses the content information server 112-1 to which the video distribution format A corresponds, and acquires the run time information of the content X in the video distribution format A. As illustrated by an arrow A13, the server 111 calculates and holds a proportion (a viewed proportion) of the content X that has been viewed on the device 113-1 based on the acquired information.

In order for the user to view the continuation of the content X in the video distribution format B on the device 113-2, as illustrated by an arrow A14, the device 113-2 accesses the server 111. In response, as illustrated by an arrow A15, the server 111 accesses the content information server 112-2 to which the video distribution format B corresponds, and acquires the run time information of the content X in the video distribution format B. As illustrated by an arrow A16, the server 111 calculates the reproduction start point information of the content X in the video distribution format B based on the viewed proportion of the content X with regard to the device 113-1 that is stored, and the run time information of the content X in the video distribution format B that is acquired. Subsequently, as illustrated by an arrow A17, the server 111 transmits the calculated reproduction start point information to the device 113-2.

As described above, in the video distribution system 100, the device 113-2 can smoothly perform the reproduction succession from the device 113-1.

Note that, with regard to the video distribution system 100 of FIG. 3, the arrows A11 to A17 are not all in time series order, and as long as the functionality can be realized, the order may be rearranged.

With regard to the arrow A13, description is given of an example in which the viewed proportion that serves as the calculation result is held; however, the point in time from the beginning (for example, 105 minutes) and the run time information thereof (for example, 120 minutes) may be held. In this case, with regard to the arrow A16, after calculating the viewed proportion, the point of the viewed proportion in the video distribution format B of the content X is calculated to be 100.625 minutes.

### Configuration Example of Server

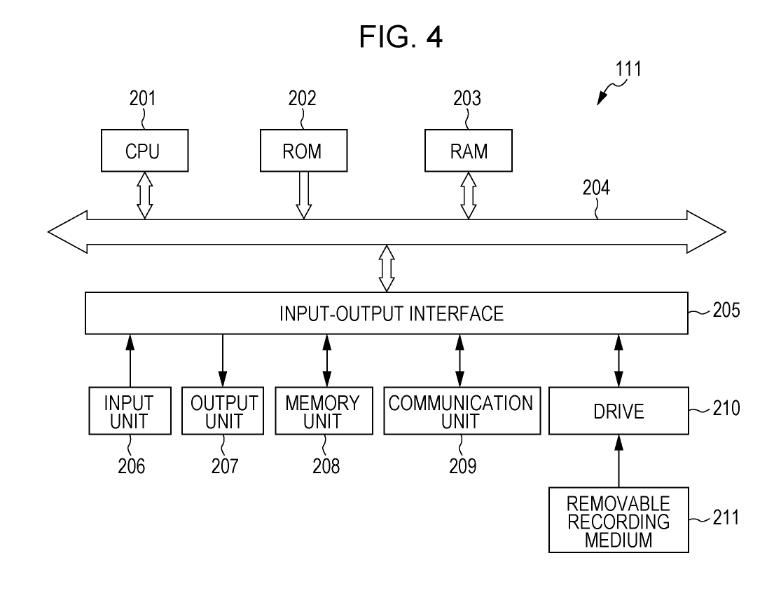

FIG. 4 is a block diagram illustrating a configuration example of the server 111.

In the server 111, a central processing unit (CPU) 201, a read only memory (ROM) 202, and a random access memory (RAM) 203, are interconnected by a bus 204.

An input-output interface 205 is further connected to the bus 204. An input unit 206, an output unit 207, a storage unit 208, a communication unit 209, and a drive 210 are connected to the input-output interface 205.

The input unit 206 is formed of a keyboard, a mouse, a microphone, or the like. The output unit 207 is formed of a display, a speaker, or the like. The storage unit 208 is formed of a hard disk, non-volatile memory or the like. The communication unit 209 is formed of a network interface or the like. The drive 210 drives a removable storage medium 211 such as a magnetic disk, an optical disk, a magneto-optical disk, or semiconductor memory.

In the server 111 configured as described above, a predetermined series of processes are performed by the CPU 201, for example, loading and executing a program that is stored in the storage unit 208 into the RAM 203 via the input-output interface 205 and the bus 204.

Note that, since the content information server 112 may have essentially the same configuration as the server 111, the configuration illustrated in FIG. 4 can also be used, as appropriate, as the configuration of the content information server 112.

### Configuration Example of Device

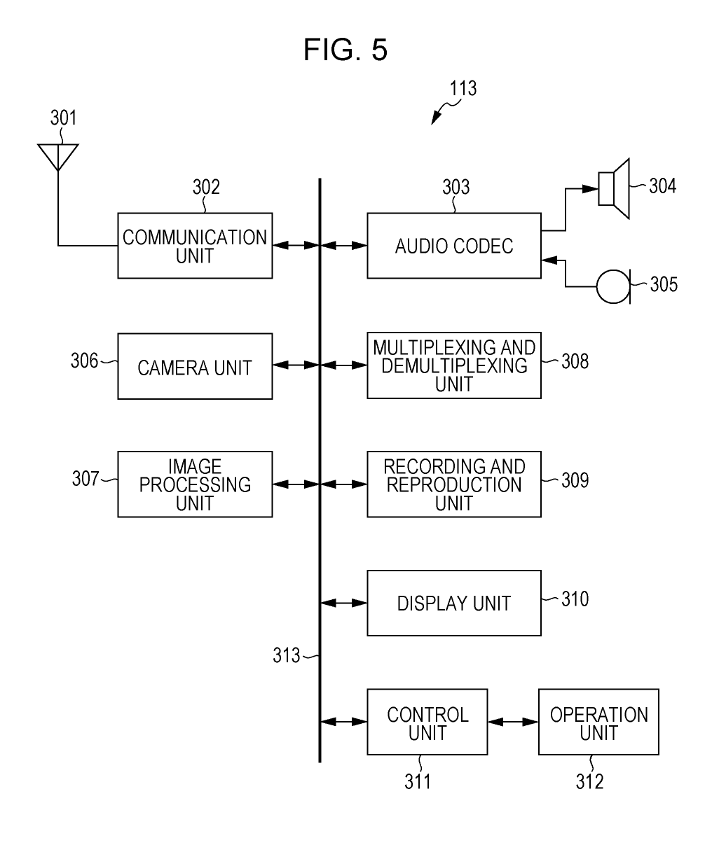

FIG. 5 is a block diagram illustrating a configuration example of the device 113. In the example of FIG. 5, the device 113 is configured of a multi-functional portable terminal, for example.

The device 113 includes a communication unit 302, an audio codec 303, a camera unit 306, an image processing unit 307, a multiplexing and demultiplexing unit 308, a recording and reproduction unit 309, a display unit 310, and a control unit 311. These are interconnected via a bus 313.

An antenna 301 is connected to the communication unit 302, and a speaker 304 and a microphone 305 are connected to the audio codec 303. Furthermore, the operation unit 312 is connected to the control unit 311.

The device 113 performs various operations such as transmission and reception of audio signals, transmission and reception of electronic mail and image data, image photography and data recording in various modes such as an audio call mode and a data communication mode.

In the audio call mode, the audio signal, which is generated by the microphone 305, is converted into audio data and data compression is performed thereon by the audio codec 303, and the result is supplied to the communication unit 302. The communication unit 302 subjects the audio data to a modulation process, a frequency conversion process, or the like, and generates the transmission signal. The communication unit 302 supplies the transmission signal to the antenna 301 and transmits the transmission signal to a base station (not shown). The communication unit 302 subjects the received signal that is received by the antenna 301 to the amplification, the frequency conversion process, the demodulation process, and the like, and supplies the obtained audio data to the audio codec 303. The audio codec 303 performs data expansion of the audio data and conversion to an analogue audio signal, and outputs the result to the speaker 304.

In the data communication mode, when performing the mail transmission, the control unit 311 receives character data that is input by the operation of the operation unit 312, and displays the characters that are input on the display unit 310. The control unit 311 generates the mail data based on the user commands and the like in the operation unit 312, and supplies the mail data to the communication unit 302. The communication unit 302 subjects the mail data to the modulation process, the frequency conversion process, and the like, and transmits the obtained transmission signal from the antenna 301. The communication unit 302 subjects the received signal that is received by the antenna 301 to the amplification, the frequency conversion process, the demodulation process, and the like, and restores the mail data. The mail data is supplied to the display unit 310, and the display of the mail content is carried out.

Note that, the device 113 can also cause the recording and reproduction unit 309 to store the mail data that is received on a storage medium. The storage medium is an arbitrary re-writable storage medium. Examples of the storage medium include semiconductor memory such as RAM and built-in flash memory, a hard disk, a magnetic disk, a magneto optical disk, an optical disk, universal serial bus (USB) memory, or a removable medium such as a memory card.

When transmitting image data in the data communication mode, the image data that is generated by the camera unit 306 is supplied to the image processing unit 307. The image processing unit 307 subjects the image data to the encoding process and generates the encoded data.

The multiplexing and demultiplexing unit 308 multiplexes the encoded data that is generated by the image processing unit 307 and the audio data that is supplied from the audio codec 303 using a predetermined method, and supplies the multiplexed data to the communication unit 302. The communication unit 302 subjects the multiplexed data to the modulation process, the frequency conversion process, and the like, and transmits the obtained transmission signal from the antenna 301.

The communication unit 302 subjects the received signal that is received by the antenna 301 to the amplification, the frequency conversion process, the demodulation process, and the like, and restores the multiplexed data. The multiplexed data is supplied to the multiplexing and demultiplexing unit 308.

The multiplexing and demultiplexing unit 308 demultiplexes the multiplexed data, and supplies the encoded data to the image processing unit 307 and the audio data to the audio codec 303. The image processing unit 307 subjects the encoded data to the decoding process and generates the image data. The image data is supplied to the display unit 310, and the display of the image that is received is carried out. The audio codec 303 converts the audio data into an analogue audio signal, supplies the analogue audio signal to the speaker 304, and outputs the received audio.

In the device 113 that is configured as described above, the control unit 311 is formed of a CPU or the like, and predetermined processes are performed due to the control unit 311 loading a program into the RAM that serves as the storage medium and executing the program.

### Functional Configuration Example of Server

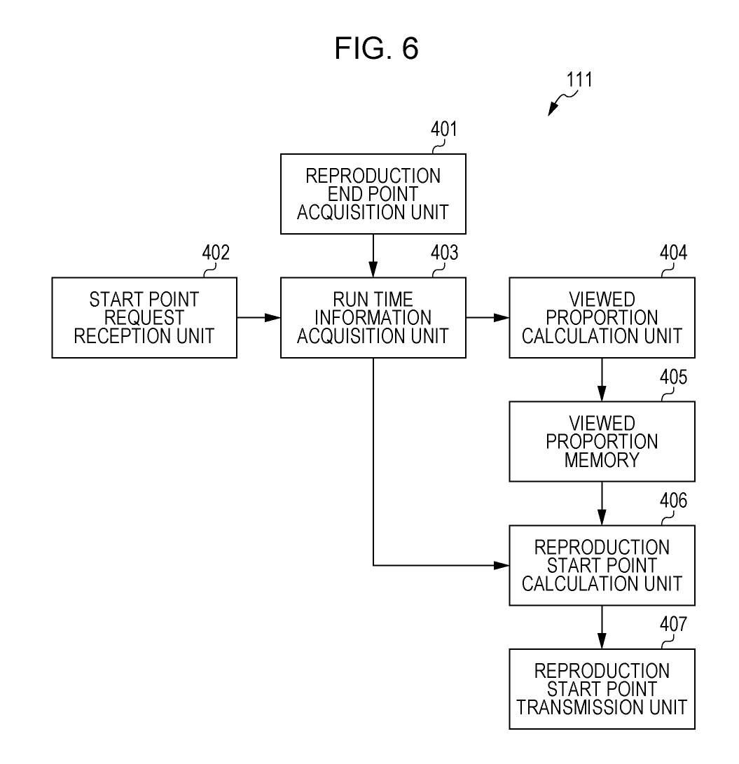

FIG. 6 is a diagram illustrating the configuration of the function in the server 111 that is realized by the CPU 201 which executes the program.

By executing the program, the CPU 201 realizes a reproduction end point acquisition unit 401, a start point request reception unit 402, a run time information acquisition unit 403, a viewed proportion calculation unit 404, a viewed proportion memory 405, a reproduction start point calculation unit 406, and a reproduction start point transmission unit 407.

For example, a user Y reproduces the content X on the device 113-1 in the video distribution format A held by the server 111 until a certain point, and ends the reproduction. In response, the reproduction end point acquisition unit 401 acquires the reproduction end point information of the content X in the video distribution format A from the device 113-1. The reproduction end point acquisition unit 401 supplies the acquired reproduction end point information to the run time information acquisition unit 403.

For example, in order for the user Y to view the continuation of the content X, which was previously viewed on the device 113-1, on the device 113-2, the device 113-2 transmits a request for the information of the point to the server 111. In response, the start point request reception unit 402 receives a reproduction start point request of the content X from the device 113-2, and supplies the received reproduction start point request to the run time information acquisition unit 403.

The run time information acquisition unit 403 acquires the run time information of the content X in the video distribution format A from the content information server 112-1 to which the video distribution format A corresponds based on the reproduction end point information from the reproduction end point acquisition unit 401. The run time information acquisition unit 403 supplies the acquired run time information of the content X in the video distribution format A and the reproduction end point information from the reproduction end point acquisition unit 401 to the viewed proportion calculation unit 404.

The run time information acquisition unit 403 acquires the run time information of the content X in the video distribution format B from the content information server 112-2 to which the video distribution format B corresponds based on the reproduction start point request from the start point request reception unit 402. The run time information acquisition unit 403 supplies the acquired run time information of the content X in the video distribution format B to the reproduction start point calculation unit 406.

The viewed proportion calculation unit 404 calculates the viewed proportion of the content X in the video distribution format A based on the run time information of the content X in the video distribution format A and the reproduction end point information from the reproduction end point acquisition unit 401, and holds the calculated viewed proportion in the viewed proportion memory 405.

The viewed proportion memory 405 holds, with regard to the device 113-1, the viewed proportion of the content X in the video distribution format A from the viewed proportion calculation unit 404.

The reproduction start point calculation unit 406 reads the viewed proportion of the content X in the corresponding video distribution format A from the viewed proportion memory 405 based on the run time information of the content X in the video distribution format B from the run time information acquisition unit 403.

The reproduction start point calculation unit 406 calculates the reproduction start point of the content X in the video distribution format B based on the viewed proportion of the content X in the video distribution format A and the run time information of the content X in the video distribution format B. The reproduction start point calculation unit 406 supplies the calculated reproduction start point of the content X in the video distribution format B to the reproduction start point transmission unit 407.

The reproduction start point transmission unit 407 transmits the reproduction start point information that is calculated by the reproduction start point calculation unit 406 to the device 113-2 that requested the information.

### Example of Video Distribution Process

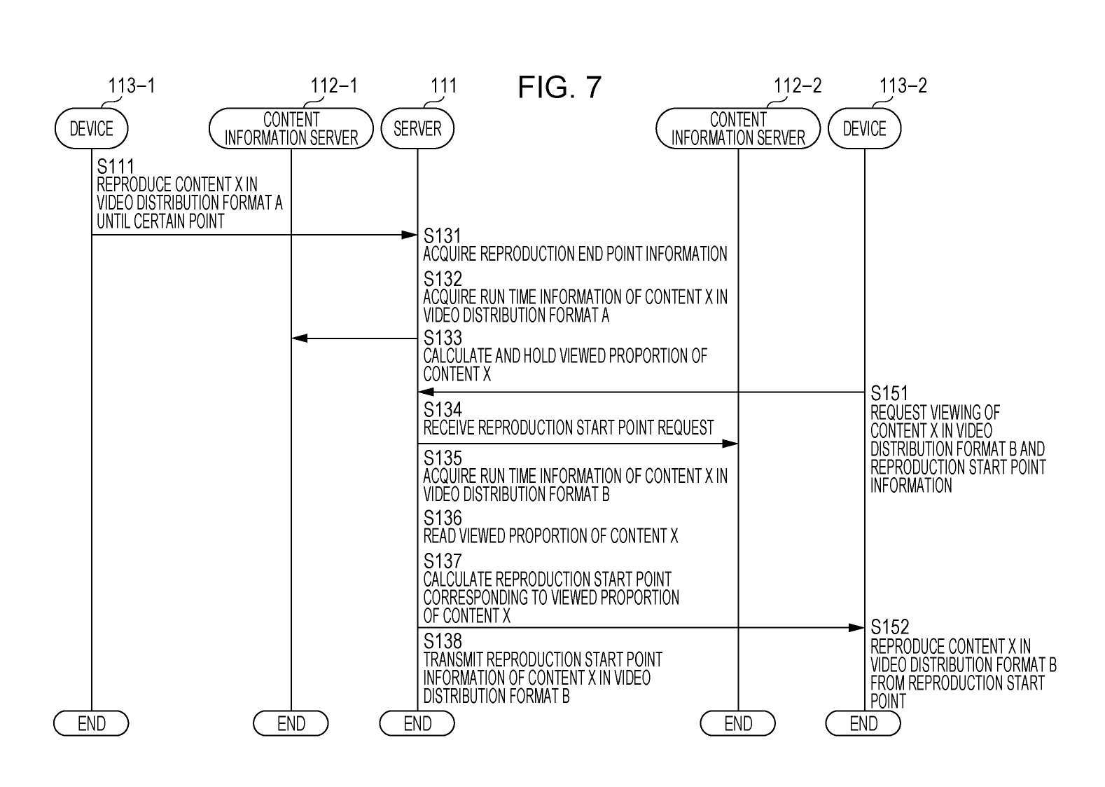

Next, description will be given of the video distribution process of the video distribution system 100 with reference to the flowchart of FIG. 7.

In step S111, in response to an operation by the user Y, the device 113-1 reproduces the content X that is held by the server 111 in the video distribution format A until a certain point (for example, a point that is 105 minutes from the beginning). In other words, the device 113-1 ends the reproduction of the content X in the video distribution format A at the 105 minute point.

In response, in step S131, the reproduction end point acquisition unit 401 of the server 111 acquires the reproduction end point information of the content X in the video distribution format A from the device 113-1. The reproduction end point acquisition unit 401 supplies the acquired reproduction end point information to the run time information acquisition unit 403.

In step S132, the run time information acquisition unit 403 acquires the run time information of the content X in the video distribution format A from the content information server 112-1 to which the video distribution format A corresponds based on the reproduction end point information from the reproduction end point acquisition unit 401. The run time information acquisition unit 403 supplies the acquired run time information of the content X in the video distribution format A and the reproduction end point information from the reproduction end point acquisition unit 401 to the viewed proportion calculation unit 404.

In step S133, the viewed proportion calculation unit 404 calculates the viewed proportion of the content X in the video distribution format A based on the run time information of the content X in the video distribution format A and the reproduction end point information from the reproduction end point acquisition unit 401, and holds the calculated viewed proportion in the viewed proportion memory 405.

For example, the next day, the user Y operates the device 113-2 in order to view the continuation of the content X on the device 113-2, which is another device. In step S151, in response to an operation by the user Y, the device 113-2 transmits a request to the server 111 for viewing the content X in the video distribution format B and the reproduction start point information.

In step S134, the start point request reception unit 402 of the server 111 receives a reproduction start point request of the content X from the device 113-2, and supplies the received reproduction start point request to the run time information acquisition unit 403.

In step S135, the run time information acquisition unit 403 acquires the run time information of the content X in the video distribution format B from the content information server 112-2 to which the video distribution format B corresponds based on the reproduction start point request from the start point request reception unit 402. The run time information acquisition unit 403 supplies the acquired run time information of the content X in the video distribution format B to the reproduction start point calculation unit 406.

In step S136, the reproduction start point calculation unit 406 reads the viewed proportion of the content X in the corresponding video distribution format A from the viewed proportion memory 405 based on the run time information of the content X in the video distribution format B from the run time information acquisition unit 403.

In step S137 the reproduction start point calculation unit 406 calculates the reproduction start point of the content X in the video distribution format B (for example, a point that is 100.625 minutes from the beginning) based on the viewed proportion of the content X in the video distribution format A and the run time information of the content X in the video distribution format B. The reproduction start point calculation unit 406 supplies the calculated reproduction start point of the content X in the video distribution format B to the reproduction start point transmission unit 407.

In step S138, the reproduction start point transmission unit 407 transmits the reproduction start point information to the device 113-2 that requested the information.

In response, in step S152, the device 113-2 reproduces the content X in the video distribution format B from the reproduction start point (for example, a point that is 100.625 minutes from the beginning).

According to the configuration described above, it is possible to smoothly perform the viewing succession of the content X. Accordingly, the user Y can comfortably view the content X.

### Second Embodiment

### Another Configuration Example of Video Distribution System

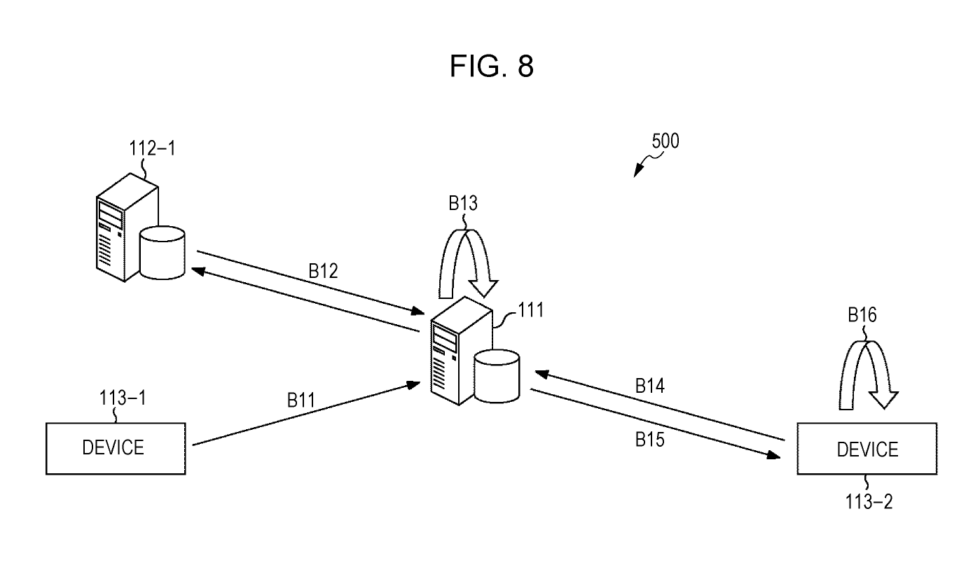

FIG. 8 is a diagram illustrating the second embodiment of a video distribution system to which an embodiment of the present technology is applied. In the example of FIG. 8, the device which first carries out the viewing performs viewing time transactions using the time from the beginning via a server; however, an example is illustrated in which the device which succeeds the viewing performs the transactions using the viewed proportion in relation to the entirety of the content X.

The configuration of a video distribution system 500 illustrated in FIG. 8 is the same as that of the video distribution system 100 of FIG. 3 in that the video distribution system 500 is provided with the server 111, the content information server 112-1, and the devices 113-1 and 113-2. The video distribution system 500 of FIG. 8 differs from the video distribution system 100 of FIG. 3 in that the content information server 112-2 is omitted.

In other words, in the video distribution system 500 of FIG. 8, as illustrated by an arrow B13, the server 111 performs the same processes as the video distribution system 100 of FIG. 3 up to the point at which the server 111 calculates and holds the proportion (the viewed proportion) of the content X that has been viewed on the device 113-1 based on the acquired information. In other words, arrows B11 to B13 of FIG. 8 may include carrying out essentially the same processes as the arrows A11 to A13 in FIG. 3, and thus, description thereof will be omitted in order to avoid repetition.

In the video distribution system 500 of FIG. 8, in order for the user to view the continuation of the content X in the video distribution format B on the device 113-2, as illustrated by an arrow B14, the device 113-2 accesses the server 111. At this time, since the device 113-2 holds the run time information of the content X in the video distribution format used thereby, the device 113-2 requests the proportion information reflecting where to perform the reproduction from.

In response, the server 111 reads the held viewed proportion of the content X in the device 113-1, and, as illustrated by an arrow B15, the viewed proportion information of the content X that is read is transmitted to the device 113-2.

As illustrated by an arrow B16, the device 113-2 calculates the reproduction start point information of the content X in the video distribution format B based on the viewed proportion information of the content X from the server 111 and the run time information of the content X in the video distribution format B of the device 113-2.

As described above, in the video distribution system 500, the device 113-2 can smoothly perform the reproduction succession from the device 113-1.

Note that, with regard to the video distribution system 500 of FIG. 8, the arrows B11 to B16 are not all in time series order, and as long as the functionality can be realized, the order may be rearranged.

### Functional Configuration Example of Server

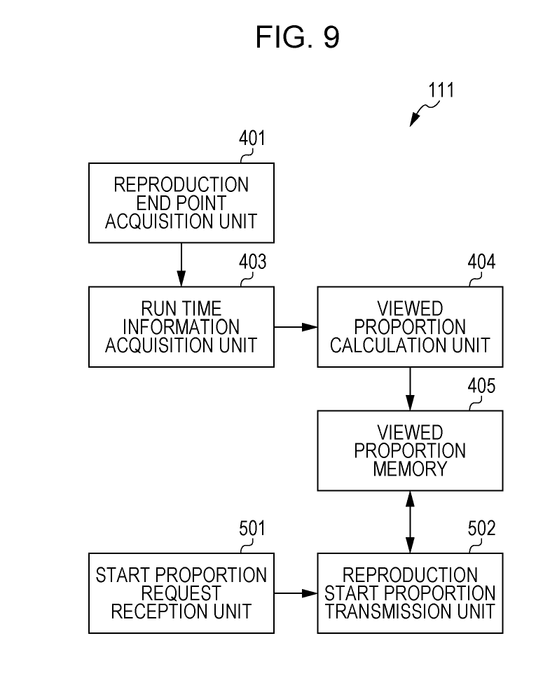

FIG. 9 is a diagram illustrating the configuration of the function in the server 111 that is realized by the CPU 201 which executes the program.

The configuration of the server 111 of FIG. 9 is the same as that of the server 111 of FIG. 6 in that the server 111 is provided with the reproduction end point acquisition unit 401, the run time information acquisition unit 403, the viewed proportion calculation unit 404, and the viewed proportion memory 405. The server 111 of FIG. 9 differs from the server 111 of FIG. 6 in that the start point request reception unit 402 is exchanged from a start proportion request reception unit 501, and in that the reproduction start point transmission unit 407 is exchanged for a reproduction start proportion transmission unit 502.

In other words, the start proportion request reception unit 501 receives a reproduction start proportion request of the content X from the device 113-2, and supplies the received reproduction start proportion request to the reproduction start proportion transmission unit 502.

When the reproduction start proportion transmission unit 502 receives the reproduction start proportion request from the start proportion request reception unit 501, the reproduction start proportion transmission unit 502 reads the corresponding viewed proportion of the content X from the viewed proportion memory 405. The reproduction start proportion transmission unit 502 transmits the viewed proportion information of the content X that is read to the device 113-2.

### Functional Configuration Example of Device

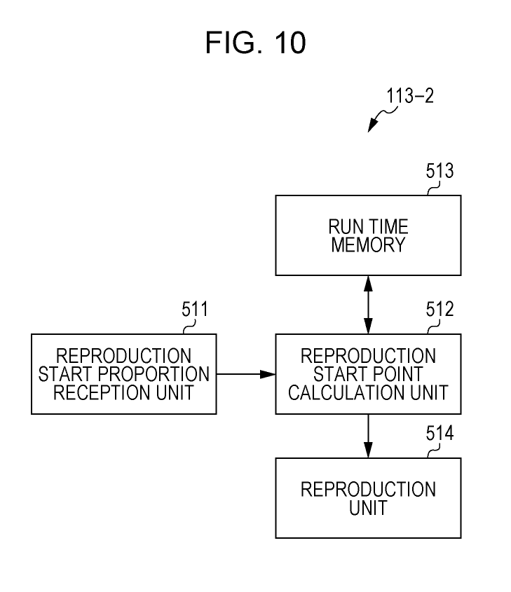

FIG. 10 is a diagram illustrating the configuration of the function in the device 113-2 that is realized by the control unit 311 which executes the program.

The control unit 311 realizes a reproduction start proportion reception unit 511, a reproduction start point calculation unit 512, a run time memory 513, and a reproduction unit 514 by executing the program.

The reproduction start proportion reception unit 511 receives the viewed proportion information of the content X from the server 111. The reproduction start proportion reception unit 511 supplies the received viewed proportion information of the content X to the reproduction start point calculation unit 512.

When the reproduction start point calculation unit 512 receives the viewed proportion information of the content X from the reproduction start proportion reception unit 511, the reproduction start point calculation unit 512 reads the run time information of the content X in the video distribution format B from the run time memory 513. The run time memory 513 holds a table of the run time information of various contents in the video distribution format B.

The reproduction start point calculation unit 512 calculates the reproduction start point (that is, a time period from the beginning of the content to the starting of the reproduction) of the content X in the video distribution format B based on the viewed proportion information of the content X and the run time information of the content X. The reproduction start point calculation unit 512 supplies the calculated reproduction start point to the reproduction unit 514.

The reproduction unit 514 starts reproducing the content X from the server 111 from the reproduction start point from the reproduction unit 514.

### Example of Video Distribution Process

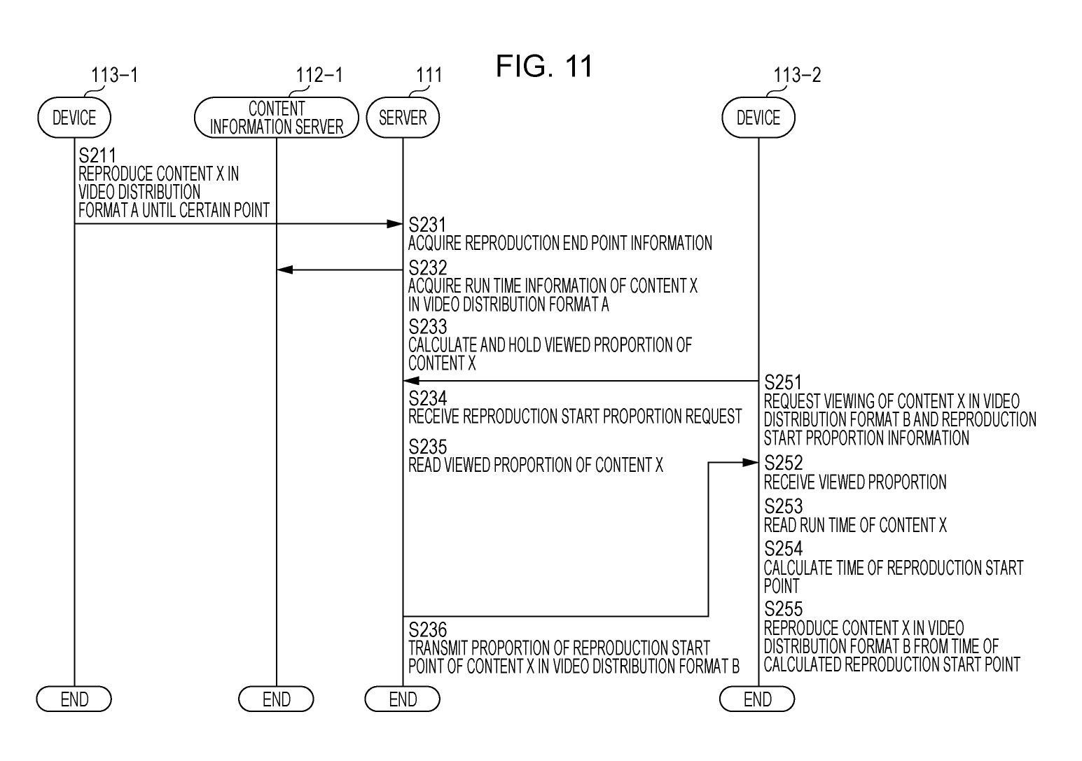

Next, description will be given of the video distribution process of the video distribution system 500 with reference to the flowchart of FIG. 11. Note that, steps S211, and S231 to S233 of FIG. 11 are essentially the same processes as steps S111, and S131 to S133 of FIG. 7, and thus, description thereof will be omitted in order to avoid repetition.

For example, at a later date, the user Y operates the device 113-2 in order to view the continuation of the content X on the device 113-2, which is another device. In step S251, in response to an operation by the user Y, the device 113-2 transmits a request to the server 111 for viewing the content X in the video distribution format B and the reproduction start proportion information.

In step S234, the start proportion request reception unit 501 of the server 111 receives a reproduction start proportion request of the content X from the device 113-2, and supplies the received reproduction start proportion request to the reproduction start proportion transmission unit 502.

In step S235, when the reproduction start proportion transmission unit 502 receives the reproduction start proportion request from the start proportion request reception unit 501, the reproduction start proportion transmission unit 502 reads the corresponding viewed proportion of the content X from the viewed proportion memory 405. In step S236, the reproduction start proportion transmission unit 502 transmits the viewed proportion information of the content X that is read to the device 113-2.

In step S252, the reproduction start proportion reception unit 511 receives the viewed proportion information of the content X from the server 111. The reproduction start proportion reception unit 511 supplies the received viewed proportion information of the content X to the reproduction start point calculation unit 512.

In step S253, when the reproduction start point calculation unit 512 receives the viewed proportion information of the content X from the reproduction start proportion reception unit 511, the reproduction start point calculation unit 512 reads the run time information of the content X in the video distribution format B from the run time memory 513.

In step S254, the reproduction start point calculation unit 512 calculates the reproduction start point (that is, a time period from the beginning of the content to the starting of the reproduction) of the content X in the video distribution format B based on the viewed proportion information of the content X and the run time information of the content X. The reproduction start point calculation unit 512 supplies the calculated reproduction start point to the reproduction unit 514.

In step S255, the reproduction unit 514 reproduces the content X from the server 111 from the reproduction start point from the reproduction unit 514.

According to the configuration described above, it is possible to smoothly perform the viewing succession of the content X. Accordingly, the user Y can comfortably view the content X.

### Third Embodiment

### Another Configuration Example of Video Distribution System

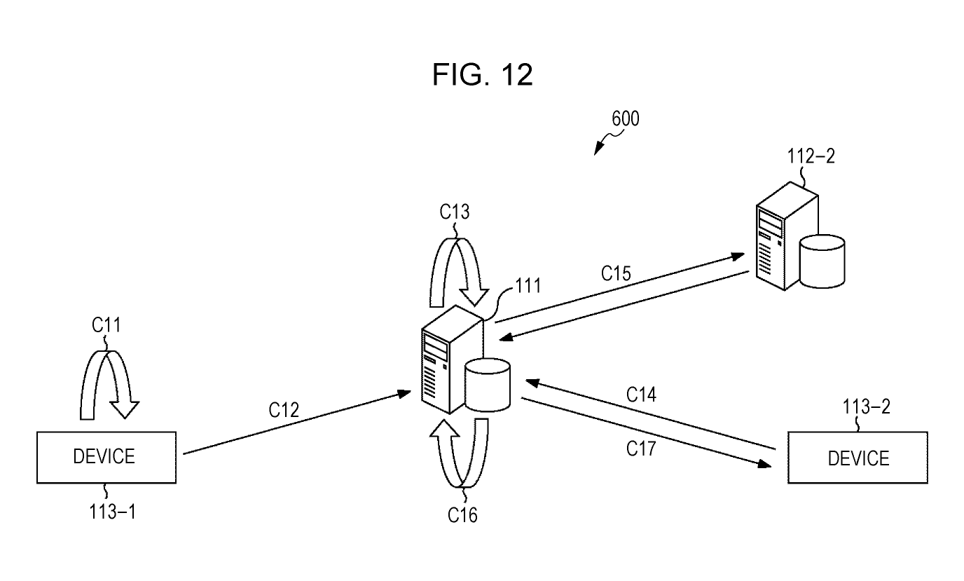

FIG. 12 is a diagram illustrating a third embodiment of a video distribution system to which an embodiment of the present technology is applied. In the example of FIG. 12, the device which first carries out the viewing through the server performs transactions using the viewed proportion in relation to the entirety of the content X; however, an example is illustrated in which the device which succeeds the viewing performs the viewing time transactions using the time from the beginning.

The configuration of a video distribution system 600 illustrated in FIG. 12 is the same as that of the video distribution system 100 of FIG. 3 in that the video distribution system 600 is provided with the server 111, the content information server 112-2, and the devices 113-1 and 113-2. The video distribution system 600 differs from the video distribution system 100 of FIG. 3 in that the content information server 112-1 is omitted. Description will be given of the video distribution system 600 of FIG. 12.

As illustrated by an arrow C11, when the device 113-1 reproduces the content X in the video distribution format A until a certain point, the device 113-1 acquires the reproduction end point information. The device 113-1 calculates the viewed proportion information of the content X in the video distribution format A based on the run time information of the content X in the video distribution format A of the device 113-1. As illustrated by an arrow C12, the device 113-1 transmits the calculated viewed proportion information of the content X in the video distribution format A to the server 111.

As illustrated by an arrow C13, the server 111 holds the viewed proportion information (for example, 87.5%) of the content X in the video distribution format A from the device 113-1.

Note that, in the video distribution system 600 of FIG. 12, as illustrated by an arrow C3, the server 111 performs the same processes as the video distribution system 100 of FIG. 3 after holding the acquired proportion. In other words, arrows C14 to C17 of FIG. 12 may include carrying out essentially the same processes as the arrows A14 to A17 in FIG. 3, and thus, description thereof will be omitted in order to avoid repetition.

As described above, in the video distribution system 600, the device 113-2 can smoothly perform the reproduction succession from the device 113-1.

Note that, with regard to the video distribution system 600 of FIG. 12, the arrows C11 to C17 are not all in time series order, and as long as the functionality can be realized, the order may be rearranged.

An example in which the viewed proportion is calculated at the arrow C11 is described; however, a configuration may be adopted in which the arrow C11 is removed, and the reproduction end point information (105 minutes) of the content X in the video distribution format A and the run time (120 minutes) of the content X are transmitted to the server 111 at the arrow C12. In this case, the proportion is calculated and held by the server 111 at the arrow C13.

### Functional Configuration Example of Device

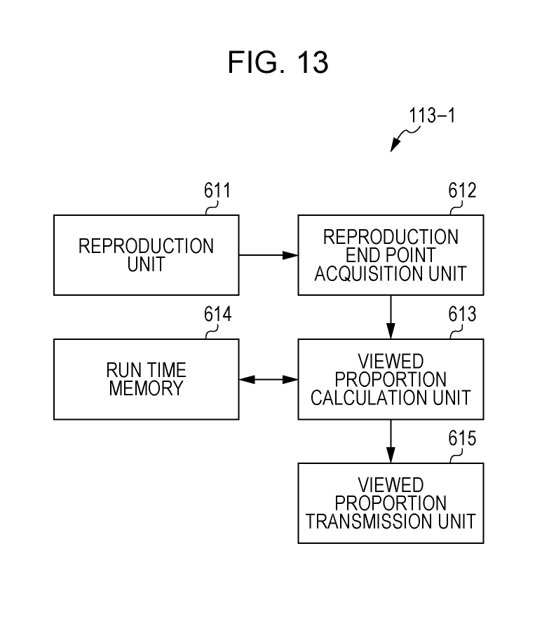

FIG. 13 is a diagram illustrating the configuration of the function in the device 113-1 that is realized by the control unit 311 which executes the program.

The control unit 311 realizes a reproduction unit 611, a reproduction end point acquisition unit 612, a viewed proportion calculation unit 613, a run time memory 614, and a viewed proportion transmission unit 615 by executing the program.

For example, in response to an operation by the user Y, the reproduction unit 611 reproduces the content X in the video distribution format A held by the server 111 until a certain point, and, in response to an operation by the user Y, ends the reproduction. In response, the reproduction end point acquisition unit 612 acquires the reproduction end point information of the content X in the video distribution format A. The reproduction end point acquisition unit 612 supplies the acquired reproduction end point information to viewed proportion calculation unit 613.

When the viewed proportion calculation unit 613 receives the reproduction end point information of the content X in the video distribution format A from the reproduction end point acquisition unit 612, the corresponding run time information of the content X in the video distribution format A is read from the run time memory 614. The run time memory 614 holds a table of the run time information of various contents in the video distribution format A.

The viewed proportion calculation unit 613 calculates the viewed proportion of the content X in the video distribution format A based on the run time information of the content X in the video distribution format A and the reproduction end point information from the reproduction end point acquisition unit 612, and supplies the calculated viewed proportion to the viewed proportion transmission unit 615.

The viewed proportion transmission unit 615 transmits the viewed proportion of the content X in the video distribution format A that is calculated by the viewed proportion calculation unit 613 to the server 111.

### Functional Configuration Example of Server

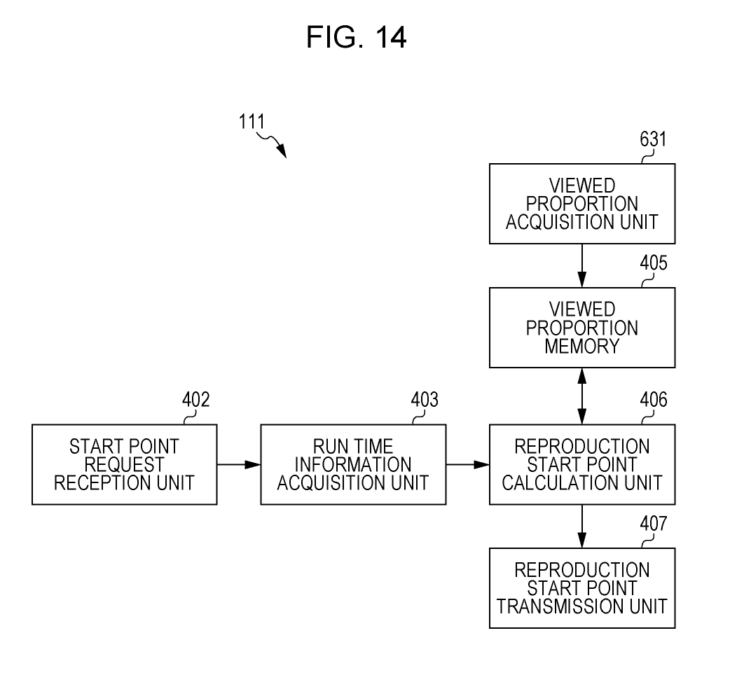

FIG. 14 is a diagram illustrating the configuration of the function in the server 111 that is realized by the CPU 201 which executes the program.

The configuration of the server 111 of FIG. 14 is the same as that of the server 111 of FIG. 6 in that the server 111 is provided with the start point request reception unit 402, the run time information acquisition unit 403, the viewed proportion memory 405, the reproduction start point calculation unit 406, and the reproduction start point transmission unit 407. The server 111 of FIG. 14 differs from the server 111 of FIG. 6 in that the reproduction end point acquisition unit 401 is exchanged for a viewed proportion acquisition unit 631, and in that the viewed proportion calculation unit 404 is omitted.

In other words, since the viewed proportion information of the content X in the video distribution format A is transmitted to the server 111 by the device 113-1, the viewed proportion acquisition unit 631 acquires the viewed proportion information and holds the viewed proportion information in the viewed proportion memory 405.

### Example of Video Distribution Process

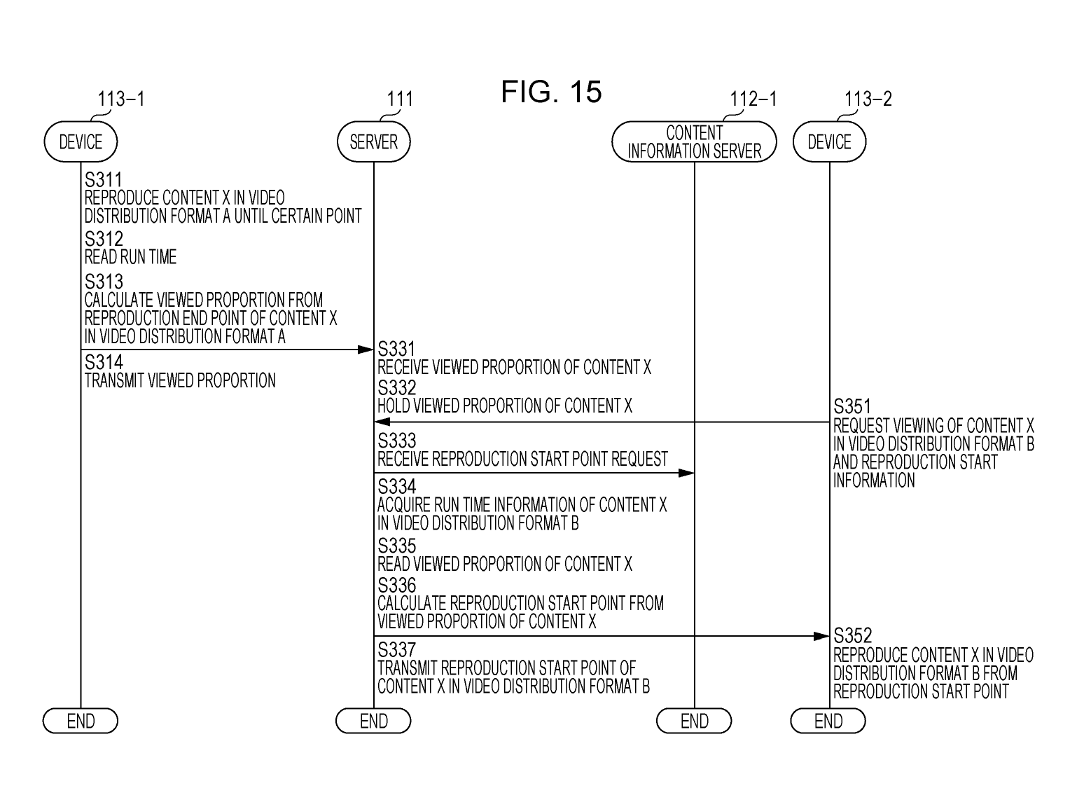

Next, description will be given of the video distribution process of the video distribution system 600 with reference to the flowchart of FIG. 15.

For example, in step S311, in response to an operation by the user Y, the reproduction unit 611 of the device A reproduces the content X in the video distribution format A held by the server 111 until a certain point, and, in response to an operation by the user Y, ends the reproduction. In response, the reproduction end point acquisition unit 612 acquires the reproduction end point information of the content X in the video distribution format A. The reproduction end point acquisition unit 612 supplies the acquired reproduction end point information to viewed proportion calculation unit 613.

When the viewed proportion calculation unit 613 receives the reproduction end point information of the content X in the video distribution format A from the reproduction end point acquisition unit 612, in step S312, the corresponding run time information of the content X in the video distribution format A is read from the run time memory 614.

In step S313, the viewed proportion calculation unit 613 calculates the viewed proportion of the content X in the video distribution format A from the run time information of the content X in the video distribution format A and the reproduction end point information from the reproduction end point acquisition unit 612, and supplies the calculated viewed proportion to the viewed proportion transmission unit 615.

In step S314, the viewed proportion transmission unit 615 transmits the viewed proportion of the content X in the video distribution format A that is calculated by the viewed proportion calculation unit 613 to the server 111.

In step S331, the viewed proportion acquisition unit 631 of the server 111 acquires the viewed proportion information of the content X in the video distribution format A that is transmitted thereto from the device 113-1. The viewed proportion acquisition unit 631 holds the acquired viewed proportion information of the content X in the video distribution format A in the viewed proportion memory 405.

Note that, steps S333 to S337, S351, and S352 of FIG. 15 may be essentially the same processes as steps S134 to S138, S151, and S152 of FIG. 7, and thus, description thereof will be omitted in order to avoid repetition.

According to the configuration described above, it is possible to smoothly perform the viewing succession of the content X. Accordingly, the user Y can comfortably view the content X.

### Fourth Embodiment

### Another Configuration Example of Video Distribution System

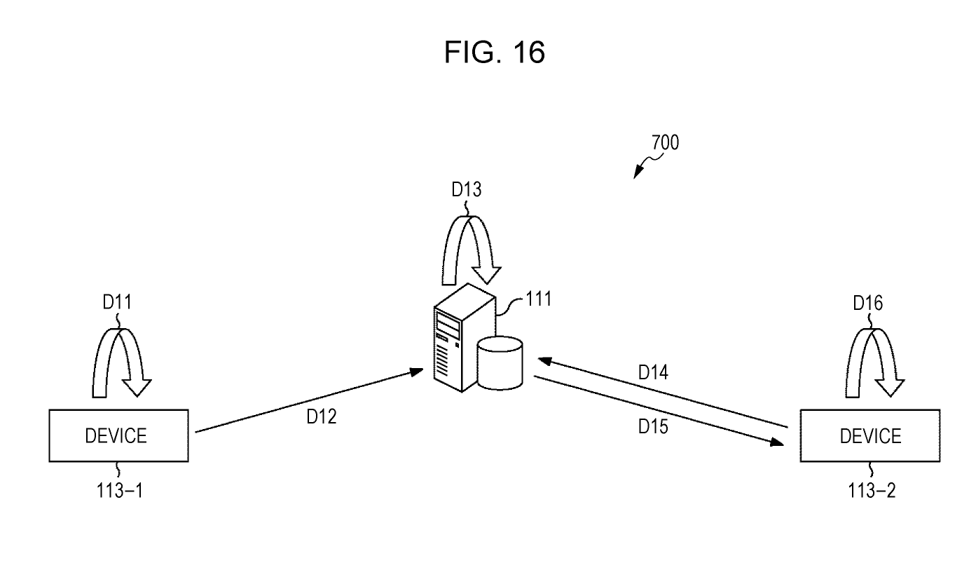

FIG. 16 is a diagram illustrating a fourth embodiment of a video distribution system to which an embodiment of the present technology is applied. In FIG. 16, an example is illustrated in which, through the server, both the device which first carries out the viewing and the device which succeeds the viewing perform the transactions using the viewed proportion in relation to the entirety of the content X.

The configuration of a video distribution system 700 illustrated in FIG. 16 is the same as that of the video distribution system 100 of FIG. 3 in that the video distribution system 700 is provided with the server 111, and the devices 113-1 and 113-2. The video distribution system 700 differs from the video distribution system 100 of FIG. 3 in that the content information servers 112-1 and 112-2 are omitted.

In other words, in the video distribution system 700 of FIG. 16, as illustrated by an arrow D13, the server 111 performs the same processes as the video distribution system 600 of FIG. 12 up to the point at which the server 111 receives and holds the proportion (the viewed proportion) of the content X that has been viewed on the device 113-1. In other words, arrows D11 to D13 of FIG. 16 may include carrying out essentially the same processes as the arrows C11 to C13 in FIG. 12, and thus, description thereof will be omitted in order to avoid repetition.

Note that, in the video distribution system 700 of FIG. 16, as illustrated by an arrow D3, the server 111 performs the same processes as the video distribution system 500 of FIG. 8 after holding the acquired proportion. In other words, arrows D14 to D16 of FIG. 16 may include carrying out essentially the same processes as the arrows B14 to B16 in FIG. 8, and thus, description thereof will be omitted in order to avoid repetition.

As described above, even in the video distribution system 700 of a case in which transactions are performed using the viewed proportion in relation to the entirety of the content X, the device 113-2 can smoothly perform the reproduction succession from the device 113-1.

Note that, with regard to the video distribution system 700 of FIG. 16, the arrows D11 to D16 are not all in time series order, and as long as the functionality can be realized, the order may be rearranged.

An example in which the viewed proportion is calculated at the arrow D11 is described; however, a configuration may be adopted in which the arrow D11 is removed, and the reproduction end point information (105 minutes) of the content X in the video distribution format A and the run time (120 minutes) of the content X are transmitted to the server 111 at the arrow D12. In this case, the proportion is calculated and held by the server 111 at the arrow D13.

Furthermore, an example in which the viewed proportion is calculated at the arrow D11 is described; however, a configuration may be adopted in which the arrow D11 is removed, and the reproduction end point information (105 minutes) of the content X in the video distribution format A and the run time (120 minutes) of the content X are transmitted to the server 111 at the arrow D12. The server 111 holds the reproduction end point information (105 minutes) and the run time (120 minutes) of the content X at the arrow D13. At the arrow D15, the server 111 informs the device 113-2 that the content X in the video distribution format B has been reproduced until the 105 minute point, and that the run time is 120 minutes. At the arrow D16, after the viewed proportion of 105/120=87.5 is calculated, 87.5% of the content X in the video distribution format B is calculated to be 100.625 minutes, and, in this case, the reproduction starts from this point.

As described above, it is possible to reorder the processes.

Note that, since the configuration of the device 113-1 of FIG. 16 may be essentially the same as the configuration of the device 113-1 in the video distribution system 600 of FIG. 12, the configuration is illustrated using the block diagram of FIG. 13. Since the configuration of the device 113-2 of FIG. 16 may be essentially the same as the configuration of the device 113-2 in the video distribution system 500 of FIG. 8, the configuration is illustrated using the block diagram of FIG. 10.

### Functional Configuration Example of Server

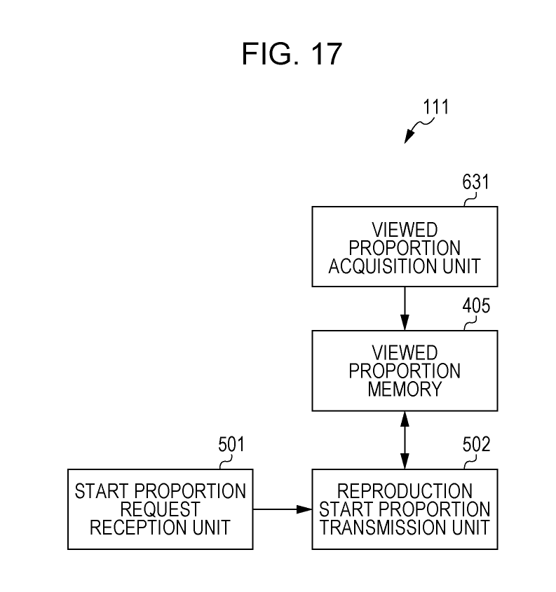

FIG. 17 is a diagram illustrating the configuration of the function in the server 111 of FIG. 16 that is realized by the CPU 201 which executes the program.

The configuration of the server 111 of FIG. 17 is the same as that of the server 111 of FIG. 9 in that the server 111 is provided with the start proportion request reception unit 501, the viewed proportion memory 405, and the reproduction start proportion transmission unit 502. The server 111 of FIG. 17 differs from the server 111 of FIG. 9 in that the reproduction end point acquisition unit 401 is exchanged for the viewed proportion acquisition unit 631 of FIG. 14, and in that the run time information acquisition unit 403 and the viewed proportion calculation unit 404 are omitted.

In other words, since the viewed proportion information of the content X in the video distribution format A is transmitted to the server 111 by the device 113-1, the viewed proportion acquisition unit 631 acquires the viewed proportion information and holds the viewed proportion information in the viewed proportion memory 405.

The start proportion request reception unit 501 receives a reproduction start proportion request of the content X from the device 113-2, and supplies the received reproduction start proportion request to the reproduction start proportion transmission unit 502. When the reproduction start proportion transmission unit 502 receives the reproduction start proportion request from the start proportion request reception unit 501, the reproduction start proportion transmission unit 502 reads the corresponding viewed proportion of the content X from the viewed proportion memory 405. The reproduction start proportion transmission unit 502 transmits the viewed proportion information of the content X that is read to the device 113-1.

### Example of Video Distribution Process

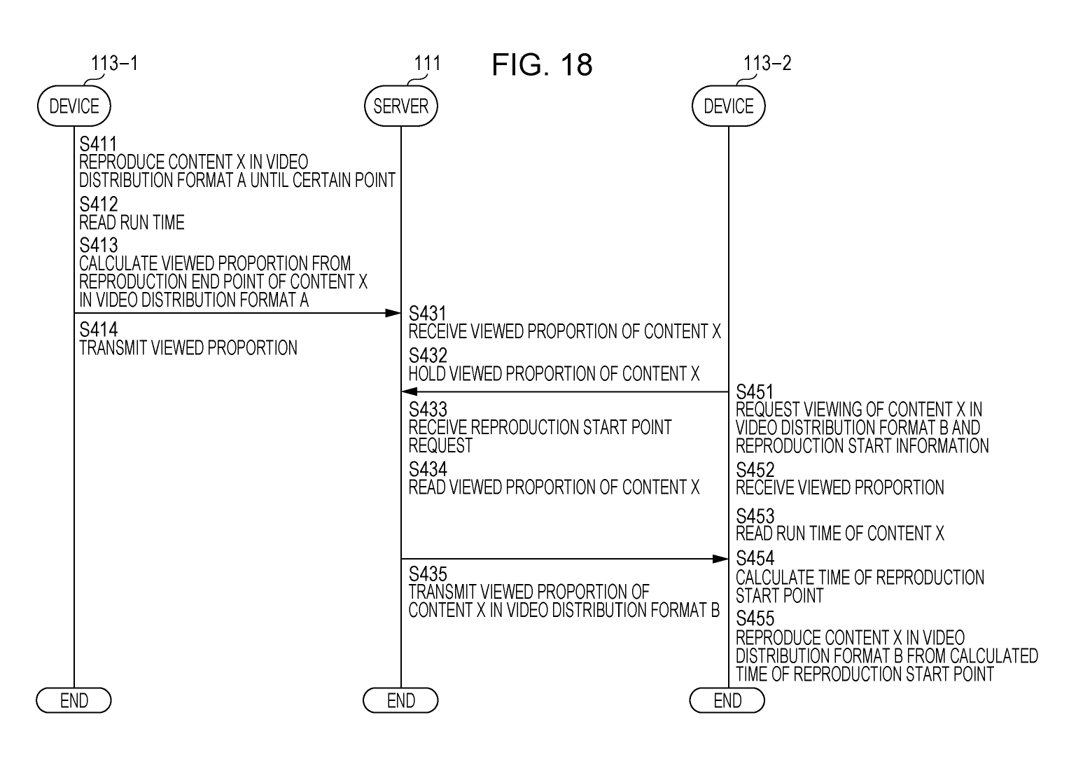

Next, description will be given of the video distribution process of the video distribution system 700 of FIG. 16 with reference to the flowchart of FIG. 18. Note that, in steps S411 to S414, S431, and S432 of FIG. 18, essentially the same processes may be performed as in the steps S311 to S314, S331, and S332 of FIG. 15. In steps S433 to S435, and S451 to S455 of FIG. 18, essentially the same processes may be performed as in the steps S234 to S236, and S251 to S255 of FIG. 11. Therefore, description of the processes of FIG. 18 will be omitted to avoid repetition.

As described above, even in the video distribution system 700 of a case in which both the device which first carries out the viewing and the device which succeeds the viewing perform the transactions using the viewed proportion in relation to the entirety of the content X, it is possible to smoothly perform the viewing succession of the content X. Accordingly, the user Y can comfortably view the content X.

Note that, in the video distribution system 700 of FIG. 16, the functionality that is realized by the server 111 that is described above can be borne by the device 113-1. In other words, the server 111 is removed from the configuration of the video distribution system 700 of FIG. 16, and the functional blocks of the server 111 of FIG. 17 are included in the device 113-1 in the video distribution system of FIG. 16.

Similarly, in the video distribution system 700 of FIG. 16, the functionality that is realized by the server 111 that is described above can be borne by the device 113-2. In other words, the server 111 is removed from the configuration of the video distribution system 700 of FIG. 16, and the functional blocks of the server 111 of FIG. 17 are included in the device 113-2 in the video distribution system of FIG. 16.

By adopting such a configuration, it is possible to realize the video distribution system 700 of FIG. 16 using only communication between the device 113-1 and the device 113-2.

In other words, even in the video distribution system of a case in which the server 111 is removed from the video distribution system 700 of FIG. 16, the device 113-2 can smoothly perform the reproduction succession from the device 113-1.

Note that, in the video distribution system described above, there is one server 111; however, the video distribution system may be configured to include a plurality of servers 111. In the video distribution system described above, an example of a configuration is illustrated in which the one content information server 112 is disposed for each video distribution format; however, a plurality of content information servers 112 may be disposed for each video distribution format. The number of types of video distribution format is not limited to two. The content information server 112 and the server 111 may be configured in a consolidated manner.

In the video distribution system described above, the device 113-1 and the device 113-2 are described as separate devices; however, it is possible to apply an embodiment of the present technology even when the content X that is viewed on the device 113-1 on one day is viewed again the next day on the device 113-1.

Furthermore, the device 113 is not limited to being a recording and reproduction device, a personal computer, a portable terminal, a multi-functional portable telephone, or the like, and the configuration of the device 113 can also be applied to a device capable of reproducing video content, such as a television device, an STB, a media reproduction device, a gaming device, and a tablet terminal.

The series of processes described above may be executed using hardware and may also be executed using software. When the series of processes is executed using software, the program configuring the software is installed on a computer. Here, examples of the computer include a computer embedded within dedicated hardware, and an ordinary personal computer or the like which is capable of executing the various functions due to various programs being installed thereon.

The program executed by the computer, for example, can be provided as a packaged medium or the like by recording the program onto the removable recording medium 211. It is possible to provide the program via a wired or wireless transmission medium such as a local area network, the Internet, or a digital satellite broadcast.

In the computer, as illustrated in FIG. 4, for example, it is possible to install the program onto the storage unit 208 via the input-output interface 205 by mounting the removable recording medium 211 into the drive 210. It is possible to install the program on the storage unit 208 by receiving the program using the communication unit 209 via a wired or wireless transmission medium. Additionally, it is possible to install the program beforehand on the ROM 202 or the storage unit 208.

Note that, the program which the computer executes may be a program in which the processes are performed in time series order in the order described in the present specification. The program may also be a program in which the processes are performed in parallel or at a necessary timing such as when the process is called.

In the present specification, the term “system” refers to the entirety of a device which is configured of a plurality of devices, blocks, units, or the like.

Note that, the embodiments of the present disclosure are not limited to the embodiments described above, and various modifications may be made within a scope not departing from the main concept of the present disclosure.

Detailed description of the favorable embodiments of the present disclosure is given above with reference to the appended drawings; however, the disclosure is not limited to the examples therein. It is clear to a person skilled in the art of the present disclosure that various modifications and corrections may be made within the technical concepts described in the claims. Naturally, such modifications and corrections are understood to fall within the technical scope of the present disclosure.

Note that, an embodiment of the present disclosure may adopt the following configurations.

(1) An information processing device, including a viewed proportion calculation unit which calculates a viewed proportion of content in a first video distribution format based on a reproduction end point of the content in the first video distribution format that is acquired from an information processing terminal that reproduces the content in the first video distribution format and run time information of the content in the first video distribution format, a viewed proportion memory which holds the viewed proportion of the content in the first video distribution format that is calculated by the viewed proportion calculation unit, and a viewed proportion reading unit which reads the viewed proportion of the content in the first video distribution format that is held in the viewed proportion memory in response to a reproduction start request of the content in a second video distribution format that differs from the first video distribution format.
(2) The information processing device according to (1), further including a reproduction start point calculation unit which calculates a reproduction start point of the content in the second video distribution format based on the viewed proportion of the content in the first video distribution format that is read by the viewed proportion reading unit and run time information of the content in the second video distribution format.
(3) The information processing device according to (2), further including a run time information acquisition unit which acquires the run time information of the content in the second video distribution format from another information processing device.
(4) The information processing device according to (1), further including a reproduction start point transmission unit which transmits a reproduction start point of the content in the second video distribution format that is calculated by the reproduction start point calculation unit to an information processing terminal that sends the reproduction start request of the content in the second video distribution format thereto.
(5) The information processing device according to (4), in which the information processing terminal that reproduces the content in the first video distribution format and the information processing terminal that sends the reproduction start request of the content in the second video distribution format are the same information processing terminal.
(6) The information processing device according to (4), in which the information processing terminal that reproduces the content in the first video distribution format and the information processing terminal that sends the reproduction start request of the content in the second video distribution format are different information processing terminals.
(7) The information processing device according to (1), further including a viewed proportion transmission unit which transmits the viewed proportion of the content in the first video distribution format that is read by the viewed proportion reading unit to an information processing terminal that sends the reproduction start request of the content in the second video distribution format thereto.
(8) The information processing device according to (7), in which the information processing terminal that reproduces the content in the first video distribution format and the information processing terminal that sends the reproduction start request of the content in the second video distribution format are the same information processing terminal.
(9) The information processing device according to (7), in which the information processing terminal that reproduces the content in the first video distribution format and the information processing terminal that sends the reproduction start request of the content in the second video distribution format are different information processing terminals.
(10) The information processing device according to (1), further including a run time information acquisition unit which acquires the run time information of the content in the first video distribution format from another information processing device.
(11) An information processing method performed by an information processing device, the method including calculating a viewed proportion of content in a first video distribution format based on a reproduction end point of the content in the first video distribution format that is acquired from an information processing terminal that reproduces the content in the first video distribution format and run time information of the content in the first video distribution format, and holding the viewed proportion of the content in the first video distribution format in a viewed proportion memory, and reading the viewed proportion of the content in the first video distribution format that is held in the viewed proportion memory in response to a reproduction start request of the content in a second video distribution format that differs from the first video distribution format.
(12) An information processing terminal, including a viewed proportion calculation unit which calculates a viewed proportion of content in a first video distribution format based on a reproduction end point of the content in the first video distribution format and run time information of the content in the first video distribution format, and a viewed proportion transmission unit which transmits the viewed proportion of the content in the first video distribution format that is calculated by the viewed proportion calculation unit to an information processing device.
(13) The information processing terminal according to (12), further including a reproduction start request unit which performs a reproduction start request of the content in a second video distribution format that differs from the first video distribution format, a viewed proportion reception unit which receives the viewed proportion of the content in the first video distribution format that is sent thereto from the information processing device in response to a request by the reproduction start request unit, and a reproduction start point calculation unit which calculates a reproduction start point of the content in the second video distribution format based on the viewed proportion of the content in the first video distribution format that is received by the viewed proportion reception unit and the run time information of the content in the second video distribution format.
(14) The information processing terminal according to (13), further including a reproduction unit which reproduces the content in the second video distribution format based on the reproduction start point of the content in the second video distribution format that is calculated by the reproduction start point calculation unit.
(15) The information processing terminal according to (12), further including a reproduction unit which reproduces the content in the first video distribution format.
(16) An information processing method performed by an information processing terminal, the method including calculating a viewed proportion of content in a first video distribution format based on a reproduction end point of the content in the first video distribution format and run time information of the content in the first video distribution format, and transmitting the viewed proportion of the content in the first video distribution format that is calculated to an information processing device.
(17) A program for causing a computer to function as a viewed proportion calculation unit which calculates a viewed proportion of content in a first video distribution format based on a reproduction end point of the content in the first video distribution format and run time information of the content in the first video distribution format, and a viewed proportion transmission unit which transmits the viewed proportion of the content in the first video distribution format that is calculated by the viewed proportion calculation unit to an information processing device.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device, comprising:
a viewed proportion calculation unit which calculates a viewed proportion of content in a first video distribution format based on a reproduction end point of the content in the first video distribution format that is acquired from an information processing terminal that reproduces the content in the first video distribution format and run time information of the content in the first video distribution format;
a viewed proportion memory which holds the viewed proportion of the content in the first video distribution format that is calculated by the viewed proportion calculation unit; and
a viewed proportion reading unit which reads the viewed proportion of the content in the first video distribution format that is held in the viewed proportion memory in response to a reproduction start request of the content in a second video distribution format that differs from the first video distribution format.

2. The information processing device according to claim 1, further comprising:
a reproduction start point calculation unit which calculates a reproduction start point of the content in the second video distribution format based on the viewed proportion of the content in the first video distribution format that is read by the viewed proportion reading unit and run time information of the content in the second video distribution format.

3. The information processing device according to claim 2, further comprising:
a run time information acquisition unit which acquires the run time information of the content in the second video distribution format from another information processing device.

4. The information processing device according to claim 1, further comprising:
a reproduction start point transmission unit which transmits a reproduction start point of the content in the second video distribution format that is calculated by the reproduction start point calculation unit to an information processing terminal that sends the reproduction start request of the content in the second video distribution format thereto.

5. The information processing device according to claim 4,
wherein the information processing terminal that reproduces the content in the first video distribution format and the information processing terminal that sends the reproduction start request of the content in the second video distribution format are the same information processing terminal.

6. The information processing device according to claim 4,
wherein the information processing terminal that reproduces the content in the first video distribution format and the information processing terminal that sends the reproduction start request of the content in the second video distribution format are different information processing terminals.

7. The information processing device according to claim 1, further comprising:
a viewed proportion transmission unit which transmits the viewed proportion of the content in the first video distribution format that is read by the viewed proportion reading unit to an information processing terminal that sends the reproduction start request of the content in the second video distribution format thereto.

8. The information processing device according to claim 7,
wherein the information processing terminal that reproduces the content in the first video distribution format and the information processing terminal that sends the reproduction start request of the content in the second video distribution format are the same information processing terminal.

9. The information processing device according to claim 7,
wherein the information processing terminal that reproduces the content in the first video distribution format and the information processing terminal that sends the reproduction start request of the content in the second video distribution format are different information processing terminals.

10. The information processing device according to claim 1, further comprising:
a run time information acquisition unit which acquires the run time information of the content in the first video distribution format from another information processing device.

11. An information processing method performed by an information processing device, the method comprising:
calculating a viewed proportion of content in a first video distribution format based on a reproduction end point of the content in the first video distribution format that is acquired from an information processing terminal that reproduces the content in the first video distribution format and run time information of the content in the first video distribution format, and holding the viewed proportion of the content in the first video distribution format in a viewed proportion memory; and
reading the viewed proportion of the content in the first video distribution format that is held in the viewed proportion memory in response to a reproduction start request of the content in a second video distribution format that differs from the first video distribution format.

12. An information processing terminal, comprising:
a viewed proportion calculation unit which calculates a viewed proportion of content in a first video distribution format based on a reproduction end point of the content in the first video distribution format and run time information of the content in the first video distribution format; and
a viewed proportion transmission unit which transmits the viewed proportion of the content in the first video distribution format that is calculated by the viewed proportion calculation unit to an information processing device.

13. The information processing terminal according to claim 12, further comprising:
a reproduction start request unit which performs a reproduction start request of the content in a second video distribution format that differs from the first video distribution format;
a viewed proportion reception unit which receives the viewed proportion of the content in the first video distribution format that is sent thereto from the information processing device in response to a request by the reproduction start request unit; and
a reproduction start point calculation unit which calculates a reproduction start point of the content in the second video distribution format based on the viewed proportion of the content in the first video distribution format that is received by the viewed proportion reception unit and the run time information of the content in the second video distribution format.

14. The information processing terminal according to claim 13, further comprising:
a reproduction unit which reproduces the content in the second video distribution format based on the reproduction start point of the content in the second video distribution format that is calculated by the reproduction start point calculation unit.

15. The information processing terminal according to claim 12, further comprising:
a reproduction unit which reproduces the content in the first video distribution format.

16. An information processing method performed by an information processing terminal, the method comprising:
calculating a viewed proportion of content in a first video distribution format based on a reproduction end point of the content in the first video distribution format and run time information of the content in the first video distribution format; and
transmitting the viewed proportion of the content in the first video distribution format that is calculated to an information processing device.

17. A program for causing a computer to function as:
a viewed proportion calculation unit which calculates a viewed proportion of content in a first video distribution format based on a reproduction end point of the content in the first video distribution format and run time information of the content in the first video distribution format; and
a viewed proportion transmission unit which transmits the viewed proportion of the content in the first video distribution format that is calculated by the viewed proportion calculation unit to an information processing device.
